(19) United States
(12) Patent Application Publication
(10) Pub. No.: US 2019/0381642 A1
(43) Pub. Date: Dec. 19, 2019

(54) INSTALLATION AID

(71) Applicant: A. Raymond et Cie SCS, Grenoble (FR)

(72) Inventor: Martin BÜSCH, Efringen-Kirchen (DE)

(21) Appl. No.: 16/468,178

(22) PCT Filed: Dec. 8, 2017
(86) PCT No.: PCT/EP2017/082037

§ 371 Date: Jun. 10, 2019

(30) Foreign Application Priority Data
Dec. 13, 2016 (DE) 10 2016 014 746.6

(51) Int. Cl. B25B 27/20; B25B 27/28

(52) U.S. Cl. CPC B25B 27/20; B25B 27/28

(57) ABSTRACT

A mounting aid for mounting a snap ring or anti-creep ring is disclosed, the mounting aid comprising a first finger and a second finger, wherein the first finger and the second finger are arranged next to one another. A first end of the first finger is arranged adjacent to a first end of the second finger; the first end of the first finger can be moved, counter to a force, from a position that is more distant from the first end of the second finger into a position that is closer to the first end of the second finger. The first end of the first finger and the first end of the second finger form a receptacle for a ring at least when the first end of the first finger is located in the position that is closer to the first end of the second finger.

### CROSS-REFERENCE TO RELATED APPLICATIONS

This application is the National Stage of International Application No. PCT/EP2017/082037, filed on 8 Dec. 2017, which claims priority to and all advantages of German Patent Application No. 10 2016 014 746.6, filed on 13 Dec. 2016, the content of which is hereby incorporated by reference.

### FIELD OF THE INVENTION

The subject invention generally relates to a mounting aid for mounting a snap ring or anti-creep ring, and to a method for mounting a snap ring or anti-creep ring with such a mounting aid.

### BACKGROUND OF THE INVENTION

Devices with which the mounting of an annular formation can be performed are known. For example, U.S. Pat. No. 4,141,129 A discloses a mounting aid for mounting an O-ring, in which the O-ring can be displaced along an interior space of a mounting aid, wherein the O-ring is initially arranged obliquely in the interior space and is displaced in oblique orientation by pressing a tappet along the interior space. The mounting aid of U.S. Pat. No. 4,141,129 A has a stop which is arranged at the end and which needs to be aligned with the groove in which the O-ring is to be placed. If the O-ring is displaced through the interior space, it abuts against the stop and is pressed into the groove upon further displacement.

Such a mounting aid has the uncertainty that not every mounting process results in a properly seated O-ring. The use of the mounting aid requires experience and practice, since the stop for the intended seat for the O-ring must be aligned accordingly; the O-ring is not visible during mounting in the groove, since the O-ring is located in the interior space and is displaced there. The required experience and practice makes the mounting aid known from U.S. Pat. No. 4,141,129 seem practical only for experienced users, wherein the mounting process per se cannot be observed since the O-ring is located in the interior space and the result of the mounting process can only be assessed when the mounting aid is set down.

### SUMMARY OF THE INVENTION

The subject invention provides a mounting aid for mounting a snap ring or anti-creep ring, the mounting aid comprising a first finger and a second finger, wherein the first finger and the second finger are arranged next to one another, a first end of the first finger being arranged adjacent to a first end of the second finger. The first end of the first finger can be moved, counter to a force, from a position that is more distant from the first end of the second finger into a position that is closer to the first end of the second finger. The first end of the first finger and the first end of the second finger form a receptacle for a ring, at least when the first end of the first finger is located in the position that is closer to the first end of the second finger. A slide contacts the first finger and can be slid from a position that is more distant from the first end of the first finger into a position that is closer to the first end of the first finger, and thereby moves the first end of the first finger, counter to a force, from the position that is more distant from the first end of the second finger into the position that is closer to the first end of the second finger.

The central idea of the invention is to use fingers which are preloaded relative to one another via a force, and the ends of which form a receptacle for a ring, wherein a slide is provided which contacts at least one of the fingers. The slide can be displaced along the finger, thereby displacing the end of the finger counter to the force and moving the fingers into a position closer to one another. In view of the slide, the force with which at least one of the fingers can be spread away from the other can be overcome, and the fingers can be moved into a position closer to one another. With the slide, the distance of the fingers relative to one another, and thus the size or the circumference of the end of the fingers, can be varied. The receptacle for a ring at the first end of the fingers can thus be varied with respect to their circumference. If the fingers are in a position closer to one another, the circumference is smaller than if the fingers are at a position that is more distant from one another. The receptacle can thus be smaller than the ring, so that the latter can be moved from the receptacle or cannot be held therein. In the position at which the ends of the fingers are more distant from one another, a ring located in the receptacle may be held with or in the receptacle by holding the ring via a non-positive fit or positive fit. The ring may be stretched or compressed in the receptacle to such a degree that the circumference of the ring is very slightly more or less than the circumference of the ring which arises if no force acts on the ring. In the non-positive fit, positive fit, or in the stretched or compressed form, the ring can be fed to a mounting location; the ring remains in the receptacle since a force acts on the ring so that the ring cannot leave the receptacle. In this position, the ring can be mounted from the receptacle in that the ring located in the receptacle leaves the receptacle at the mounting location, wherein the ring may be at least partially exposed in the receptacle so that the ring can interact at the mounting location with material present there. A reliable positioning of the ring is possible.

Within the meaning of the description, a snap ring or an anti-creep ring is to be understood as an annular, in particular elastic, element. The ring may in particular be substantially a ring comprising a metal. In particular, the ring can substantially consist of spring steel wire. In particular, the ring can be a snap ring as a circlip for screw connections. Within the meaning of the description, the term “snap ring” also includes a shaft circlip or a bore circlip. Within the meaning of the description, the term “ring” is not to be understood to be limiting in terms of its geometry, since geometries deviating from the circular shape may also be provided in a snap ring or an anti-creep ring, for example radially or axially corrugated rings but also oval or ellipsoidal shapes. It can in particular be provided that the ring is designed to be open over a section so that the ring does not need to be closed circumferentially. Within the meaning of the description, the term “anti-creep ring” also includes an annular element which can in particular reinforce a panel of soft material which can be produced from plastic, for example.

Within the meaning of the description, the term “finger” includes a finger-shaped component which can be designed as an elongated component. If the description states that the first finger and the second finger are arranged next to one another, this arrangement includes the arrangement of the two fingers such that the fingers extend substantially in the same direction. The fingers may be arranged about a longitudinal axis, wherein the two fingers are arranged about the longitudinal axis in parallel with the longitudinal axis or with slight deviation from the longitudinal axis. It can be provided that one of the fingers is arranged parallel to a longitudinal axis and only one of the fingers can assume a deviation from the longitudinal axis. One of the fingers may be arranged rigidly relative to the longitudinal axis, while the other finger may describe a variable angle relative to the longitudinal axis in order to be able to be changed between the more distant position and the closer position. Deviations from the longitudinal axis or the common extent in substantially the same direction comprise a deviation of typically less than 30°, alternatively less than 20°, alternatively less than 15°.

The fingers may have substantially the same length in the longitudinal direction. However, it is also possible for a finger which is in particular substantially fixed in its position to be shorter or longer than the finger that is movable in its position. The fingers may have substantially the same design transversal to the longitudinal direction. In particular, at least one finger may have a section of a substantially circular or elliptical shape with respect to its longitudinal cross-section. The two fingers can have such a respective longitudinal cross-section that a circular or elliptical shape substantially results when the first ends of the fingers are moved into the position closer to one another.

The fingers may be arranged symmetrically about a longitudinal axis. The fingers may be arranged angularly equidistantly about a longitudinal axis, wherein the fingers may describe different or the same circumferences about the longitudinal axis.

The fingers can be fixed to one another via a fixing, wherein a fixing can be spaced apart from the first end of the fingers so that the first ends of the fingers can assume the more distant position and/or the closer position without the action of the fixing. The fixing can be formed integrally with one of the fingers, in particular with a finger which substantially does not move in order to move the first ends into a position closer to one another. In particular, the fixing may be spaced from the first end of at least one of the fingers. The fixing may be realized in the form of a clamping or a positive connection. The finger or fingers may be connected to a base of the fixing. In one embodiment, the fingers may be connected to one another or braced against one another. The fingers may form a clamp-like arrangement that is negatively preloaded (in the open position), wherein the fingers can form legs of the clamp.

The use of the ordinal numbers “first” and “second” with respect to the fingers does not highlight any of the fingers as a particular finger, but rather simply provides a possibility to name the fingers, which may be of identical design, and to be able to refer to named fingers. The use of the ordinal numbers “first” and “second” also does not preclude the presence of further fingers, for example a third finger or additional fingers. If the first and second fingers are designed differently, if or there is a structural difference with respect to the fingers, the third finger can be designed like the first or the second finger. Each further finger may be designed in accordance with one shape or another shape.

Within the meaning of the invention, the arrangement includes a first end of the first finger being arranged adjacent to a first end of the second finger, in particular the possibility of the ends being arranged close to one another and lying in a plane which can in particular enclose an angle near 90° relative to the longitudinal axis of the fingers, or to a longitudinal axis about which the fingers can be arranged.

The force counter to which the first end of the first finger can be moved from a position that is more distant from the first end of the second finger into a position that is closer to the first end of the second finger can be any mechanical force which can act on one or both of the fingers. In particular, the force may be a force exerted by an elastic element, in particular a spring. It may also be that the force is exerted on the first end of the second finger by a lever. A hydraulic force that must be overcome in order to move the first end of the first finger from a position that is more distant from the first end of the second finger to a position that is closer to the first end of the second finger may alternatively or additionally be provided.

Within the meaning of the description, the term “receptacle,” which is designed for the ring, includes the provision of contact points for the ring at the first end of the fingers. The contact points may extend in the radial or axial direction of the finger. The contact points can also be of planar design so that a planar receptacle can be present. The receptacle can be structured or profiled. The receptacle can have knob-like projections as contact points. For example, a receptacle may be designed to have contact points that are directed against an inner contour of the ring. For example, it can then be provided that the receptacle can engage behind the ring from the inside. In order to securely hold the ring in the receptacle, the first ends of the fingers can therefore be first moved into a position close to one another and the ring can be put on. In order to form a non-positive fit of the ring in the receptacle, the slide can be moved back into a position at a distance from the first end so that the two fingers spread again.

In certain embodiments, the ring may be radially surrounded by the receptacle. A section of the first ends of the fingers may at least partially surround the ring from the outside. The outer surface of the ring may be in contact with the receptacle. An additional contact at the first end of the fingers, in the direction of the longitudinal axis of the fingers, is possible so that contact points which extend substantially in the axial direction of the finger or the longitudinal axis of the fingers can also be provided. The receptacle can be formed at least partially from contact points which, when connected, form an L-shape as viewed in the circumferential direction of the ring. At least in sections, the receptacle can be designed to be L-shaped, wherein the small leg of the L can be directed inwards. The ring can thus be held between the fingers. Such an arrangement allows access to the ring from the region arranged between the fingers.

The receptacle can support the ring in the radial and/or axial direction of the longitudinal axis of the finger, wherein minor deviations of the radial or axial direction in the range of less than 20° deviation, alternatively less than 10° deviation, alternatively less than 5° deviation, are not ruled out. In particular, the receptacle can be designed in such a way that the ring accommodated in the receptacle is exposed in such a way that the height extent (thickness) of the ring, which is oriented substantially parallel to the longitudinal axis of the fingers or the longitudinal axis about which the fingers are arranged, is present with a larger portion outside the receptacle. The extent of the receptacle in the direction of the longitudinal axis of the fingers or the longitudinal axis about which the fingers are arranged may be adapted to the thickness of the ring, such that this extent is less than 50% of the thickness of the ring, alternatively less than 40% of the thickness of the ring, alternatively less than 35% of the thickness of the ring. In certain embodiments, the receptacle is designed in such a way that the extent in the longitudinal direction of the fingers or the longitudinal axis about which the fingers are arranged is substantially approximately 33% of the thickness of the ring. The extent of the receptacle in the direction transversal to the longitudinal axis of the fingers or the longitudinal axis about which the fingers are arranged may be adapted to the radial extent of the ring, such that this extent is less than 50% of the radial extent of the ring, alternatively less than 40% of the radial extent of the ring, alternatively less than 35% of the radial extent of the ring. As a result, the ring can be accessed between the fingers from inside, and a ring located in the receptacle can in particular be ejected from the receptacle.

The term “slide” within the meaning of the description includes an element which can be moved in a substantially translational direction. The slide is substantially moved in one direction. The direction can be predetermined by the longitudinal extent of the fingers or the longitudinal axis about which the fingers are arranged. The direction may correspond to the direction of the fingers.

In various embodiments, the slide comprises a rolling element or sliding element, the slide contacting the first finger with the rolling element or sliding element and the rolling element or sliding element moving on the first finger when the slide is slid from the position that is more distant from the first end of the first finger into the position that is closer to the first end of the first finger. The rolling element or sliding element can in particular be a roller or a sliding surface. A rolling element designed as a roller can roll on the first finger, wherein the roller can be arranged such that the roller axis is oriented substantially transversal to the longitudinal axis of the finger. The roller can have a counter-element, which can in particular also have one or more rollers. A constant distance can be present between the roller and the counter-element, said distance being adapted to the distance of the fingers relative to the first end when the first ends of the fingers are in the closer position. The roller can be displaced with the counter-element from a position adjacent to the second end of the fingers toward the first end of the fingers, and exert on the finger a counterforce compensating at least the force that can preload the fingers in the position in which they are more distant from one another. The roller with the counter-element can compress the fingers adjacent to the first end. A rolling element designed as a roller can also be oriented in such a way that the roller axis runs substantially parallel to the longitudinal axes of the fingers or the longitudinal axis about which the fingers are arranged. The roller may be a plastic ring that can be rolled or displaced with the slide from a position that is more distant from the first end of the first finger to a position adjacent to the first end of the first finger. The diameter of the roller can be adapted to the distance of the fingers from the first end when the first ends of the fingers are in the closer position, so that the roller displaced toward the first end of the fingers exerts on the finger a counterforce compensating at least the force that can preload the fingers in the position in which they are more distant from one another.

The sliding element can have a sliding surface that can slide off the first finger, wherein a counter-face for the sliding surface can be provided on the first finger. The slide element may form a slide bearing with the first finger. The sliding surface may be designed such that the sliding surface presses the finger counter to the force when the sliding surface is displaced toward the first end of the finger.

It can be provided that the rolling element or the sliding element is designed as a wearing part, wherein the rolling element or the sliding element can be an element comprising plastic.

It is essential for the rolling element and/or the sliding element that such an element contacts the first finger and can be moved relative to the first finger and, during the movement, that the first end of the first finger is moved, counter to the force, from the position that is more distant from the first end of the first finger into the position that is closer to the first end of the first finger. The description refers in this respect to a relative movement of the first end of the first finger relative to the first end of the second finger; in this respect, the first finger and/or the second finger can move relative to the element and/or the slide. A relative movement of the first ends of the two fingers relative to one another can be achieved in that a relative movement of both fingers relative to the rolling element and/or sliding element is carried out, or only a movement of one finger is present.

In various embodiments, the slide comprises a rolling element or sliding element with which the slide contacts the second finger, wherein the rolling element or sliding element moves on the second finger when the slide is slid from the position that is more distant from the first end of the first finger into the position that is closer to the first end of the first finger. A simple design of the mounting aid can thereby be achieved. The slide, with the rolling element or the sliding element which contacts the second finger, can form a counter-element to the rolling element or sliding element which can contact the first finger. A support of the two rolling elements or sliding elements is possible. It is in particular possible for one finger to be contacted by a rolling element and one finger to be contacted by a sliding element. Contacting of a finger with a rolling element and a sliding element is possible.

To the extent that reference is made to the rolling element and/or sliding element moving on one of the fingers, it is not excluded that a section of the rolling element and/or sliding element is also located under or next to at least one of the fingers. The description of the term “on” refers to the rolling element and/or the sliding element being located at a position that can be handled or accessed by the user, and to the fingers being able to be preloaded relative to one another in the open position of the first end. In various embodiments, the rolling element and/or sliding element is arranged in such a way that the element is located in a region which is arranged around the fingers. The rolling element and/or sliding element has an acting surface which contacts the one of the fingers and, upon acting, can move the first end of the finger onto the first end of the other of the fingers. The rolling element and/or sliding element can in particular contact an outer surface or a surface of an outwardly directed finger. In particular, an outer surface or an outwardly directed surface can be a surface extending radially from the longitudinal axis of the finger or the longitudinal axis around which the fingers can be arranged.

In various embodiments, the slide at least partially surrounds the first finger and the second finger. An element which is designed to be annular or elliptical at least in sections may be used as a slide. The slide may have a shape formed from sections of a ring or an ellipse. The slide may be integrally formed or be formed of several parts that can be parts of a ring shape or ellipse shape. The slide may be formed of half-shells or other sub-divisions or sections of an annular or ellipsoidal shape.

In various embodiments, the mounting aid comprises a mounting tappet that is arranged between the first finger and the second finger and can slide from a position more distant from the first end of the first finger into a position that is closer to the first end of the first finger. The term “mounting tappet” within the meaning of the description includes a tappet-like element which can be moved relative to one or both of the fingers. The movement may be in the longitudinal direction of the fingers or along the longitudinal axis between the fingers. The ring can be acted upon during the movement so that the ring can leave the receptacle and can be moved to the position provided for assembly.

In various embodiments, an expansion spring is provided which is connected at one end to the mounting tappet and abuts with another end against the first finger, or abuts with the other end against an end of a pin whose other end abuts against the first finger. Any form of application of force can be selected here. It is also possible to provide a pneumatically applied force in addition to an elastic element, which may in particular be designed as an expansion spring. The provision of a pin between the expansion spring and the finger is one possibility of providing an indirect action of the expansion spring on the finger. As a result, in addition to a direct action of the expansion spring on the finger, an indirect action can be provided so that the expansion spring does not necessarily need to come into contact with the first finger. Providing an expansion spring, which may be connected to the mounting tappet, creates the possibility of also assigning to the mounting tappet the action of spreading apart the two fingers, in addition to an ejection of the ring from the receptacle. The function of the ejection and the function of preloading the fingers relative to one another can be at least assisted or executed with the mounting tappet. The term “end” in relation to the pin also includes the meaning of the section end of the pin, so that the expansion spring can abut against a section end of the pin formed by, for example, a cross-sectional variation in the longitudinal direction of the pin. The expansion spring may also engage at a projection or a recess of the pin.

In various embodiments, the first finger has a chamfer at its first end, the second finger additionally or alternatively having a chamfer at its first end. As a result, the ring can be more easily received. A centering aid for the ring can also be designed. However, the chamfer may additionally or alternatively also be designed to be outside the receptacle, so that the outer contour of the fingers in the region of the first end may be reduced in order to be able to insert the first end into narrow regions. With the outer contour of the fingers in the region of the first end, a possibility for centering the mounting aid relative to the mounting location of the ring is also possible. Within the meaning of the description, the term “chamfer” includes a taper that does not necessarily need to be linear. Deviations are possible here. Any reduction in the outer dimensions of the outer contour of the fingers may be interpreted as a chamfer.

In various embodiments, a housing that partially surrounds the first finger and the second finger is provided, wherein the housing has an end opening from which the first end of the first finger and the first end of the second finger project. A housing offers the possibility of simplified handling in that the housing can be gripped. In addition, a protection of the fingers and/or mounting tappets arranged in the housing can be achieved with said housing. Apertures and openings in the housing can allow access to the fingers and/or further elements of the mounting aid, in particular to the mounting tappet, so that maintenance and/or repair of the mounting aid can be carried out without opening the housing.

The invention also provides a method for mounting a snap ring or anti-creep ring with a mounting aid described above. The ring is inserted into the receptacle for a ring and held there in that the slide has been slid from the position that is more distant from the first end of the first finger into the position that is closer to the first end of the first finger, and thereby the first end of the first finger has been moved from the position that is more distant from the first end of the second finger into the position that is closer to the first end of the second finger, and the ring has thereby been compressed.

In various embodiments, the ring held in the receptacle partially projects beyond the first end of the first finger and the first end of the second finger. This makes it easier to handle the ring. The ring is essentially exposed in certain sections which are not covered by the receptacle. The exposed sections of the ring located in the receptacle may be used for handling or interaction with a workpiece. Stripping the ring from the mounting aid can thereby be simplified.

In various embodiments, the ring is ejected from the receptacle by pushing the mounting tappet from the position that is more distant from the first end of the first finger into the position that is closer to the first end of the second finger.

### BRIEF DESCRIPTION OF THE DRAWINGS

The invention is described in greater detail below with reference to the accompanying figures, in which:

FIG. 1 shows a device according to one embodiment of the invention in a schematic sectional side view, in a spread position with a ring;

FIG. 2 shows the device according to the invention of FIG. 1 in a schematic sectional side view, in a position receiving the ring;

FIG. 3 shows the device according to the invention of FIG. 1 in a schematic sectional side view, in a position ejecting the ring;

FIG. 4 shows an enlarged illustration of a terminal region of the device according to the invention, in a position corresponding to FIG. 1 without a ring; and

FIG. 5 shows an enlarged illustration of a terminal region of the device according to the invention, in a position corresponding to FIG. 2.

### DETAILED DESCRIPTION

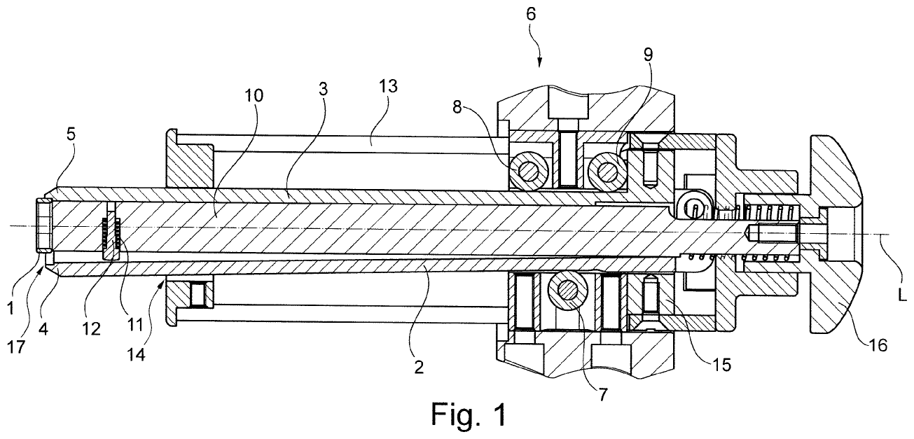

Referring to the Figures, wherein like numerals indicate corresponding parts throughout the several views, FIGS. 1 to 3 show a sectional side view of a mounting aid for mounting a ring 1 designed as a snap ring or anti-creep ring. The mounting aid comprises a first finger 2 and a second finger 3. The first finger 2 and the second finger 3 are arranged next to one another and arranged in relation to a longitudinal axis L of the mounting aid. The first finger 2 and the second finger 3 extend in substantially the same direction. A first end 4 of the first finger 2 is arranged adjacent to a first end 5 of the second finger 3.

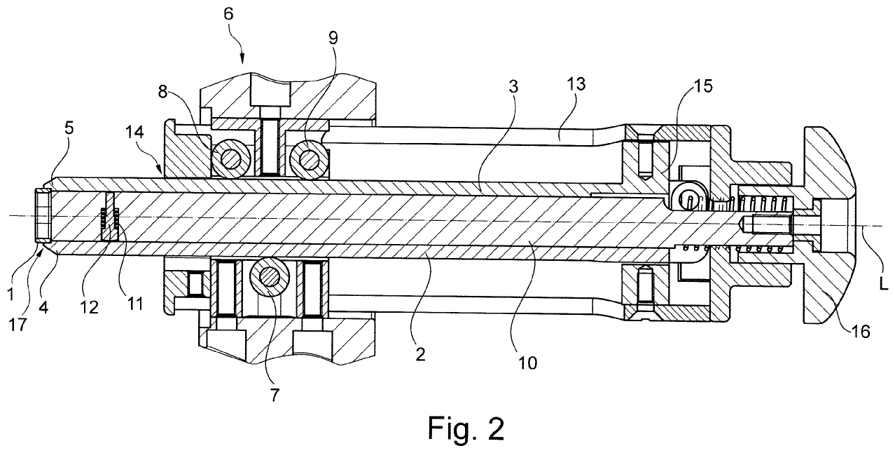

In the exemplary embodiment shown in FIGS. 1 to 3, the first end 4 of the first finger 2 can be moved counter to a force from a position that is more distant from the first end 5 of the second finger 3, as shown in FIG. 1, into a position that is closer to the first end 5 of the second finger 3, as shown in FIG. 2. On the first finger 2, a force is exerted which in particular acts in the region of the first end 4 of the first finger 2. In the position shown in FIG. 1, the first end 4 of the first finger 2 is spread away from the first end 5 of the second finger 3. The ring 1 illustrated in FIG. 1 is not held by the mounting aid.

In order to hold the ring 1 by the mounting aid, a receptacle 17 is formed, at least at the first end 4 of the first finger 2 and at the first end 5 at the second finger 3, when the first end 4 of the first finger 2 is in the position, according to FIG. 2, that is closer to the first end 5 of the second finger 3.

In order to change the relative position of the first end 4 of the first finger 2 in relation to the first end 5 of the second finger 3, a slide 6 is provided which contacts the first finger 2 and which can be slid from a position that is more distant from the first end 4 of the first finger 2 (FIG. 1) into a position that is closer to the first end 4 of the first finger 2 (FIG. 2). The first end 4 of the first finger 2 is thereby moved, counter to a force, from the position that is more distant from the first end 5 of the second finger 3 (FIG. 1) into the position that is closer to the first end 5 of the second finger 3.

The slide 6 has a rolling element 7 which contacts the first finger 2. When the slide 6 is slid from the position that is more distant from the first end 4 of the first finger 2 (FIG. 1) into the position that is closer to the first end 4 of the first finger 2 (FIG. 2), the rolling element 7 can be moved on the first finger 2.

Furthermore, the slide 6 has two rolling elements 8, 9 with which the slide 6 contacts the second finger 3, wherein the rolling elements 8, 9 move on the second finger 3 when the slide 6 is slid from the position that is more distant from the first end 4 of the first finger 2 into the position that is closer to the first end 4 of the first finger 2. The slide 6 can be supported with the rolling element 7 on the first finger 2, the rolling elements 8, 9 being counter-elements for the rolling element 7. The distance between the facing outer contours of the rolling element 7 on the side of the first finger 2 and of the rolling elements 8, 9 on the side of the second finger 3 defines the distance of the fingers 2, 3 from each other with regard to their outer dimensions. The slide 6 at least partially surrounds the first finger 2 and the second finger 3.

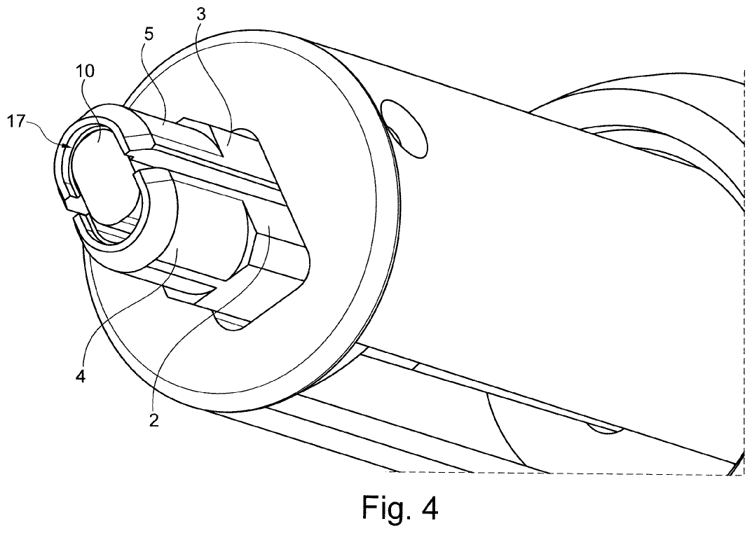

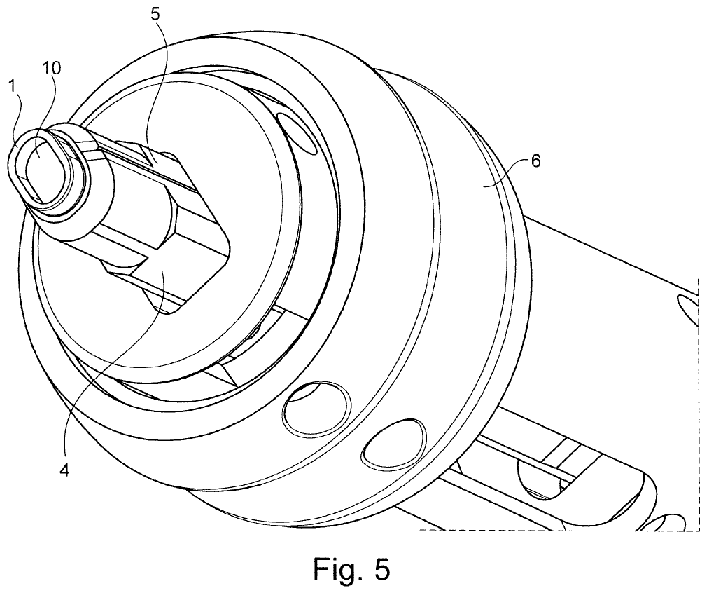

FIG. 4 shows an enlarged illustration of the mounting aid in the region of the receptacle 17 at the end on the fingers 2, 3. FIG. 4 shows the state of the mounting aid according to FIG. 1. The first end 4 of the first finger 2 is in a more distant position in comparison to the position shown in FIG. 5, which shows the state of the mounting aid according to FIG. 2, in which the first end 4 of the first finger 2 is in a position that is closer to the first end 5 of the second finger 3, wherein the ring 1 is held in the receptacle 17. For this purpose, the slide 6 is slid from the position that is more distant from the first end of the first finger 2 (FIG. 4 and FIG. 1) into the position that is closer to the first end 4 of the first finger 2 (cf. FIG. 5 and FIG. 2).

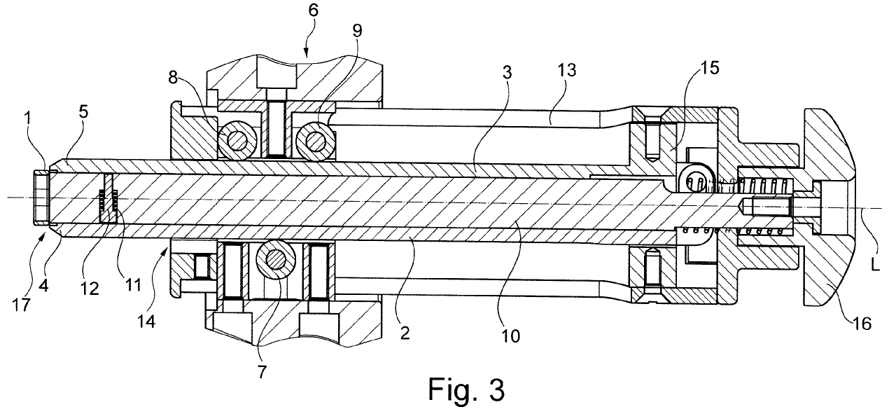

The mounting aid has a mounting tappet 10 which is arranged between the first finger 2 and the second finger 3, and which can be pushed from a position that is more distant from the first end 4 of the first finger 2 (FIG. 2) into a position that is closer to the first end 4 of the first finger 2 (FIG. 3) so that the ring 1 located in the receptacle 17 can be ejected from the receptacle 17.

In a bore arranged transversely to the longitudinal axis L on the mounting aid, in the mounting tappet 10 an expansion spring 11 is provided which is connected with one end to the mounting tappet 10 and which, with the other end, abuts against a pin 12 whose end abuts against the first finger 2. By the expansion spring 11 and the force exerted on the pin 12, a spreading force can be exerted on the first finger 2, which moves the first finger 2 into a position such that the first end 4 of the first finger 2 is in a position that is more distant from the first end 5 of the second finger 3 (FIG. 1). When the slide 6 is moved from the position that is more distant from the first end 4 of the first finger 2 (FIG. 1) into the position that is closer to the first end 4 of the first finger 2 (FIG. 2), the rolling element 7 acts on the first finger 2 in such a way that the pin 12 dips into a bore in the mounting tappet 10, against the spring force of the expansion spring 11. The first end 4 of the first finger 2 arrives at a position that is closer to the first end 5 of the second finger 3 (FIG. 2). Other possibilities of the direction of movement of the fingers 2, 3 relative to one another are also conceivable, but are not shown. For example, a linear movement orthogonal to the longitudinal extent of the two fingers 2, 3 could take place.

The mounting tappet 10 can be actuated by a handle 16 arranged at the end on the housing 13. The mounting tappet 10 is spring-preloaded in the position that is more distant from the first end 5 of the second finger 3. In order to move the mounting tappet 10 from the position, illustrated in FIGS. 1, 2, that is more distant from the first end 4 of the first finger 2 into the position, illustrated in FIG. 3, that is closer to the first end 4 of the first finger 2, the handle 16 must be actuated in this direction, along the longitudinal direction L of the mounting aid and toward the receptacle 17 or the first end 4 of the first finger 2. The handle 16 is pressed in order to eject the ring 1 from the receptacle 17 via the mounting tappet 10.

The first finger 2 has a chamfer at its first end 4; the second finger 3 also has a chamfer at its first end 5 (cf. FIGS. 4 and 5).

The mounting aid also comprises a housing 13 which at least partially surrounds the first finger 2 and the second finger 3, the housing 13 having an end opening 14 from which the first end 4 of the first finger 2 and the first end 5 of the second finger 3 project.

The fingers 2 and 3 are fixed in the housing 13 in a fixing 15. The fixing 15 is formed integrally with the second finger 3. The finger 3 can also remain stationary during activation of the slide 6 and of the handle 16. The first finger 2 is mounted at the end via the fixing 15 so as to be movable.

With the mounting aid shown in FIGS. 1 to 3, a method for mounting a snap ring or anti-creep ring can be carried out. The ring 1 can be inserted into the receptacle 17 for a ring and be held by sliding the slide 6 from the position that is more distant from the first end 4 of the first finger 2 into the position that is closer to the first end 4 of the second finger 2, the first end 4 of the first finger 2 thereby being moved from the position that is more distant from the first end 5 of the second finger 3 into the position that is closer to the first end 5 of the second finger 3, and the ring 1 thereby being held in the receptacle 17 via a frictional connection. The ring 1 may be slightly compressed in the receptacle 17. This process can be seen in the sequence of FIGS. 1 and 2.

The method can achieve that the ring 1 held in the receptacle 17 partially projects beyond the first end 4 of the first finger 2 and the first end 5 of the second finger 3. This is visible in FIG. 2.

In the sequence of FIGS. 2 and 3, it is apparent that, with respect to the method, the ring 1 is ejected from the receptacle 17 by pushing the mounting tappet 10 from the position that is more distant from the first end 4 of the first finger 2 into the position that is closer to the first end 4 of the first finger 2.

The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, The term “about” applies to both numerical values when associated with a range of values. Moreover, the term “about” may apply to numerical values even when not explicitly stated.

Generally, as used herein a hyphen “-” or dash “-” in a range of values is “to” or “through”; a “>” is “above” or “greater-than”; a “≥” is “at least” or “greater-than or equal to”; a “<” is “below” or “less-than”; and a “≤” is “at most” or “less-than or equal to.” On an individual basis, each of the aforementioned applications for patent, patents, and/or patent application publications, is expressly incorporated herein by reference in its entirety in one or more non-limiting embodiments.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

What is claimed is:

1. A mounting aid for mounting a snap ring or anti-creep ring, the mounting aid comprising a first finger and a second finger, wherein
the first finger and the second finger are arranged next to one another,
a first end of the first finger being arranged adjacent to a first end of the second finger,
wherein the first end of the first finger can be moved, counter to a force, from a position that is more distant from the first end of the second finger into a position that is closer to the first end of the second finger,
wherein the first end of the first finger and the first end of the second finger form a receptacle for a ring, at least when the first end of the first finger is located in the position that is closer to the first end of the second finger, and
wherein a slide contacts the first finger and can be slid from a position that is more distant from the first end of the first finger into a position that is closer to the first end of the first finger, and thereby moves the first end of the first finger, counter to a force, from the position that is more distant from the first end of the second finger into the position that is closer to the first end of the second finger.

2. The mounting aid according to claim 1, wherein the slide has a rolling element or sliding element and contacts the first finger with the rolling element and/or sliding element, wherein the rolling element and/or sliding element moves on the first finger when the slide is slid from the position that is more distant from the first end of the first finger into the position that is closer to the first end of the first finger.

3. The mounting aid according to claim 1, wherein the slide has a rolling element and/or sliding element and contacts the second finger with the rolling element and/or sliding element, wherein the rolling element and/or sliding element moves on the second finger when the slide is slid from the position that is more distant from the first end of the first finger into the position that is closer to the first end of the first finger.

4. The mounting aid according to claim 1, wherein the slide at least partially surrounds the first finger and the second finger.

5. The mounting aid according to claim 1, further comprising a mounting tappet which is arranged between the first finger and the second finger and which can be pushed from a position that is more distant from the first end of the first finger into a position that is closer to the first end of the first finger.

6. The mounting aid according to claim 5, further comprising an expansion spring which is connected with one end to the mounting tappet and with another end abuting against the first finger, or with the other end abuting against one end of a pin whose other end abuts against the first finger.

7. The mounting aid according to claim 1, wherein the first finger has a chamfer at its first end and/or the second finger has a chamfer at its first end.

8. The mounting aid according to claim 1, further comprising a housing partially surrounding the first finger and the second finger, wherein the housing has an end opening from which the first end of the first finger and the first end of the second finger project.

9. A method for mounting a snap ring or anti-creep ring with a mounting aid according to claim 1, said method comprising:
inserting a ring into the receptacle; and sliding the slide from the position that is more distant from the first end of the first finger into the position that is closer to the first end of the first finger, the first end of the first finger thereby being moved from the position that is more distant from the first end of the second finger into the position that is closer to the first end of the second finger, and the ring thereby being compressed or stretched.

10. The method according to claim 9, wherein the ring held in the receptacle partially projects beyond the first end of the first finger and the first end of the second finger.

11. The method according to claim 9, wherein the ring is ejected from the receptacle by pushing a mounting tappet from the position that is more distant from the first end of the first finger into the position that is closer to the first end of the first finger.
